(19) United States
(12) Patent Application Publication
(10) Pub. No.: US 2019/0213531 A1
(43) Pub. Date: Jul. 11, 2019

(54) METHOD OF SUPPLYING INVENTORY

(71) Applicant: Target Brands, Inc., Minneapolis, MN (US)

(72) Inventors: Neal T. Anderson, Edina, MN (US); Fatima H. Ayubi, Crystal, MN (US); Andrew T. Bean, Vadnais Heights, MN (US); Sukie C. Ewald, Eden Prairie, MN (US); Amy E. Furfori, Bloomington, MN (US); Terrence J. Hornsby, JR., Minneapolis, MN (US); Katherine E. Kelly, Minneapolis, MN (US); Thomas E. McMillan, Farmington, MN (US); Michael C. Pearson, Minneapolis, MN (US); Chris W. Prater, Little Elm, TX (US); Neil Z. Witte, Edina, MN (US)

(21) Appl. No.: 16/214,732

(22) Filed: Dec. 10, 2018

Related U.S. Application Data
(60) Provisional application No. 62/615,520, filed on Jan. 10, 2018.

(51) Int. Cl. G06Q 10/08; B65D 30/00

(52) U.S. Cl. CPC G06Q 10/087; B65D 29/00; G06Q 10/0832

(57) ABSTRACT

A method of supplying inventory includes sorting inventory into flexible inventory bags or soft-sided containers. Each flexible inventory bag or soft-sided container that receives the inventory corresponds with a final desired location in a building of a retailer. Each flexible inventory bag or soft-sided container is transported to the final desired location and inventory from the flexible inventory bag or soft-sided container is set into the final desired location.

### CROSS-REFERENCE TO RELATED APPLICATION

The present application is based on and claims the benefit of U.S. provisional patent application Ser. No. 62/615,520, filed Jan. 10, 2018, the content of which is hereby incorporated by reference in its entirety.

### BACKGROUND

Retailers participate in supply chain management and logistics to control product quality, inventory levels, timing and expenses. As retail companies become more involved in digital purchases and shipments of merchandise, the more the retail companies must concentrate on the management of and logistics of their supply chain. The supply chain for a retailer includes all of the contributors involved in getting merchandise into the hands of customers and guests.

The discussion above is merely provided for general background information and is not intended to be used as an aid in determining the scope of the claimed subject matter.

### SUMMARY

A method of supplying inventory includes sorting inventory into flexible inventory bags. Each flexible inventory bag that receives inventory corresponds with a final desired location in a building of a retailer. The flexible inventory bags are loaded onto a vehicle and the flexible inventory bags are shipped from the warehouse to the building on the vehicle. The flexible inventory bags are unloaded from the vehicle into the building. Each flexible inventory bag is moved to the corresponding final desired location in the building. Inventory stored in each flexible inventory bag is set in the final desired location.

A method of supplying inventory includes receiving one or more orders for merchandise. After the one or more orders are received, one or more flexible inventory bags are moved to locations where the merchandise in each of the orders is being held. Merchandise listed in each of the orders is picked and placed into at least one flexible inventory bag. The picking and placing of the merchandise into the flexible inventory bags is repeated until the one or more orders are filled. Each flexible inventory bag that contains the merchandise that filled the one or more orders is moved to an order pick-up location or a pack station for shipping.

A method of supplying inventory includes sorting inventory into soft-sided containers. Each soft-sided container that receives the inventory corresponds with a final desired location in a building of a retailer. Each soft-sided container is transported to the final desired location and inventory from the soft-sided container is set into the final desired location.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a front view of a flexible inventory bag according to an embodiment.

FIG. 2 is a back view of the flexible inventory bag of FIG. 1.

FIG. 3 is a side view of the flexible inventory bag of FIG. 1.

FIG. 4 is a top view of the flexible inventory bag of FIG. 1.

FIG. 5 is a front view of a flexible inventory bag according to another embodiment.

FIG. 6 is a back view of the flexible inventory of FIG. 5.

FIG. 7 is a right side view of the flexible inventory bag of FIG. 5.

FIG. 8 is a left side view of the flexible inventory bag of FIG. 5.

FIG. 9 is a top view of the flexible inventory bag of FIG. 5 configured for a single interior compartment under one embodiment.

FIG. 10 is a top view of the flexible inventory bag of FIG. 5 configured for two interior compartments under one embodiment.

FIG. 11 is a top view of the flexible inventory bag of FIG. 5 configured for two interior compartments under another embodiment.

FIG. 12 is a top view of the flexible inventory bag of FIG. 5 configured for three interior compartments under one embodiment.

FIG. 13 is a bottom view of the flexible inventory bag of FIG. 5.

FIG. 14 is a schematic diagram of an aisle in a retail store that is stocked using flexible inventory bags according to an embodiment.

FIG. 15 is a diagram of supplying inventory according to an embodiment.

FIG. 16 is a flowchart illustrating the steps of supplying inventory using flexible inventory bags according to an embodiment.

FIG. 17 is a perspective view of a cart for supporting and moving flexible inventory bags according to an embodiment.

FIG. 18 illustrates a schematic diagram of one embodiment of a railing system within a trailer of a truck that holds flexible inventory bags for transport.

FIG. 19 illustrates a schematic diagram of the unloading of flexible inventory bags from the railing system in FIG. 18 onto a fixture.

FIG. 20 illustrates the fixture in FIG. 19 away from the truck in either a location in the backroom or on the store floor.

FIG. 21 illustrates another configuration of a fixture, where at the destination the fixture is split into fixtures halves.

FIG. 22 is a flowchart illustrating the steps of supplying inventory using flexible inventory bags according to another embodiment.

### DETAILED DESCRIPTION

Stocking inventory is the process of filling a retail store's shelves and displays with merchandise for sale including the management of replenishing, storing and sorting merchandise in a retailer's warehouse. For example, an inventory management system may be used to assist in keeping a retail store properly stocked and merchandise reordered when supplies are running low. Similar processes are also used to manage the transport of other inventory items for a store including the transportation of fixtures, price labels and other in-store marketing signs. The task of stocking shelves and displays is more physical in nature as stockers spend much of their time transporting, lifting and placing merchandise. Stocking inventory across a chain of retail stores is time-consuming and expensive yet an essential task. Customers and guests come to a retail store or place orders with a retailer to purchase a particular item and if that particular item is out-of-stock or unavailable, frustration results.

There are many physical processes a retailer needs in place to keep a retail store properly stocked including warehousing processes, sorting processes, shipping processes, backroom processes and sales floor processes. In one example, a vehicle arrives at a retail store from a warehouse on a regular basis with merchandise that is running low in the retail store and other inventory items for updating fixtures and signage in the store. These vehicles may be floor-loaded, loaded with palletized freight or loaded with special carts that carry bins of merchandise sorted at an aisle-level granularity. The carts are then unloaded from the truck and are transported to store aisles for stocking shelves and displays in the retail store with merchandise located in the bins.

Unfortunately, the sales floor process of stocking shelves and displays from any of the above-described options is a slow and arduous task. A stocker spends time taking merchandise by product type to a location in a store, then searching, scanning and setting the merchandise on the shelf. The stocker spends additional time going back and forth from pulling merchandise to searching, scanning and setting the merchandise on the shelf.

When a vehicle is loaded with carts and bins, the carts that carry bins also present problems. First, the carts can only be so tall or otherwise they may become tippy. For example, a cart height over 74 inches may be deemed a safety hazard. However, a 74 inch tall cart leaves the top 31 inches of a 105 inch truck trailer empty and inefficient. In addition, some of the bins may not be completely full because, for example, a particular aisle in the store only needs a few items to be restocked. Essentially, any non-merchandise object, like the bins and the carts, used to support inventory decreases truck utilization and any low restock aisles create a “light load” leaving room for air, which decreases bin utilization.

In order fulfillment, rather than customers choosing merchandise from shelves and displays, customers order merchandise on-line or by other means and either the retail store fulfills the order for pick-up or fulfills the order by shipping or sending via courier the merchandise from the store to the customer. In any scenario, the retailer picks items off of the shelf or display on the store floor or from the backroom or other warehouse space. Picking orders from a backroom of a store means team members are picking items before inventory is stocked on the store floor or picking items that are not available for purchase on the store floor. Picking orders from the store floor involves team members picking merchandise for the orders from shelves and displays amongst other shopping customers and guests. In either method, how items from an order are gathered and held for pick up or gathered and held for packing and shipping is important.

Embodiments described provide methods and processes of transporting inventory in a retail chain including supplying, stocking and fulfilling merchandise efficiently. All embodiments described include the use of flexible inventory bags for the sorting of and movement of inventory. Exemplary movements of inventory include within a node itself, for example, within a retail store, within a backroom of a retail store, within the sales floor of a retail store, within a warehouse and etc. Additional exemplary movements of inventory include from node to node, for example, from a warehouse to a backroom of a retail store, from a backroom of a retail store to the sales floor of a retail store and vice versa, from a sales floor of a retail store to order pick-up in a retail store and etc.

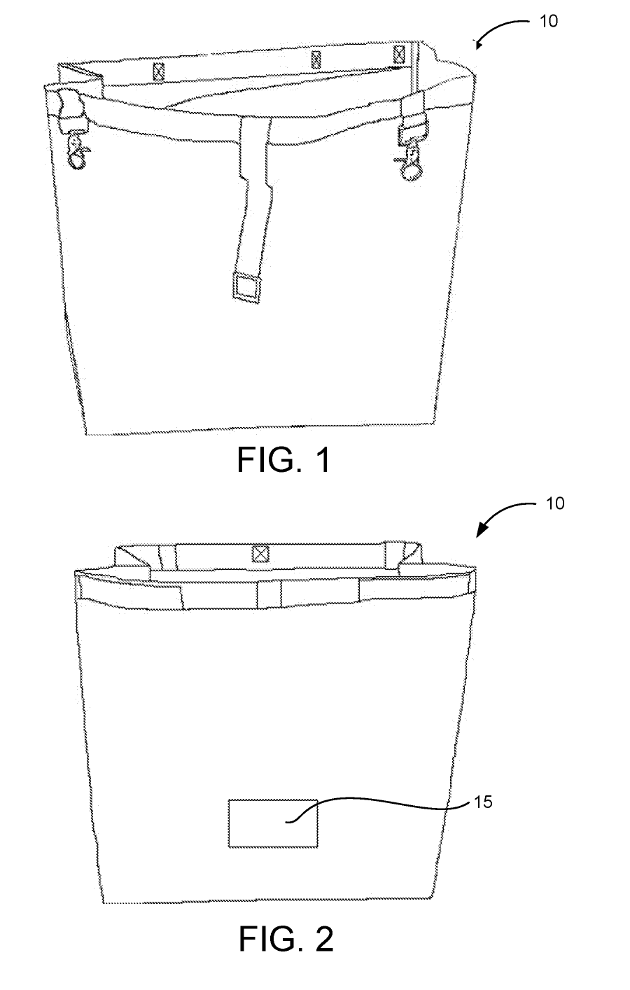

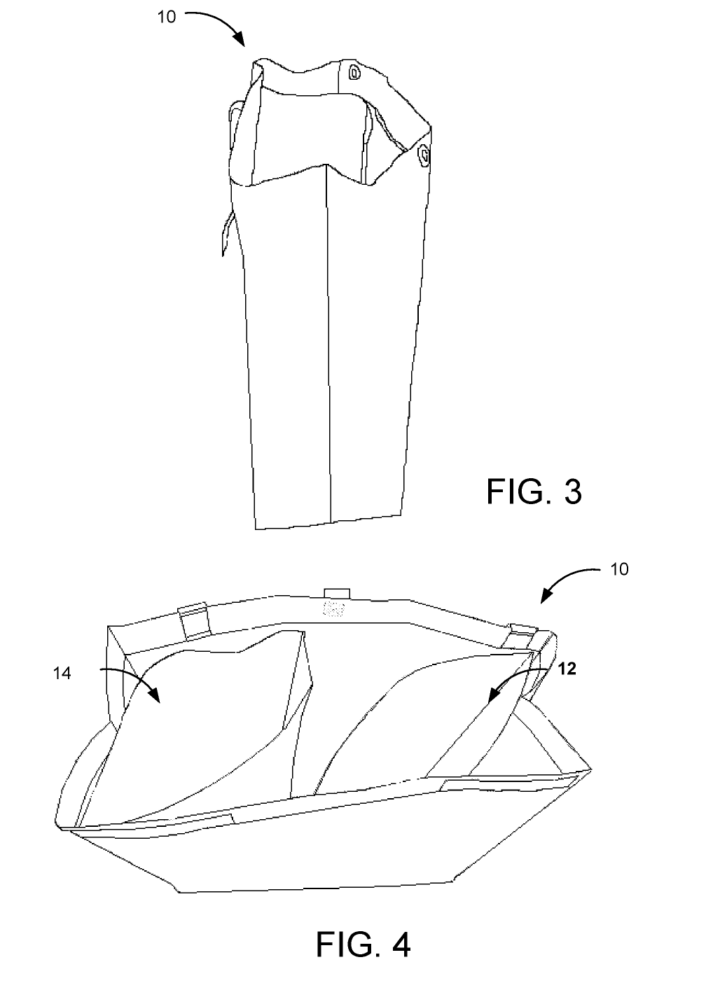

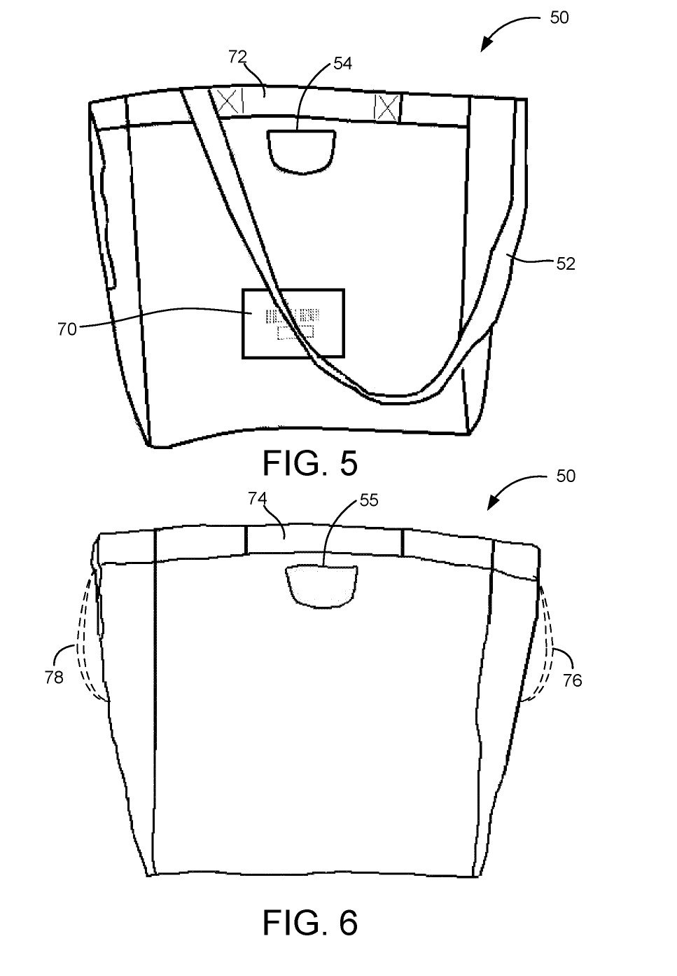

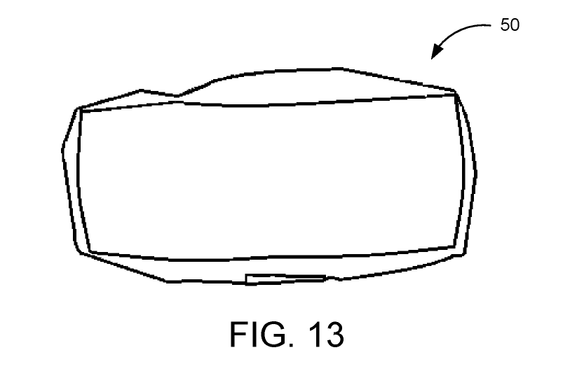

FIGS. 1-4 illustrate a front, back, side and top views of an exemplary flexible inventory bag or soft-sided container 10 according to an embodiment and FIGS. 5-13 illustrates a front, back, right side, left side, top and bottom views of an exemplary flexible inventory bag or soft-sided container 50 according to another embodiment. Flexible inventory bags or soft-sided containers 10 and 50 may be made from fabric, such as canvas as illustrated in FIGS. 1-4. In other embodiment, flexible inventory bags or soft-sided containers 10 and 50 may be made from a woven polypropylene as illustrated in FIGS. 5-13. Other fabrics that flexible inventory bags or soft-sided containers 10 and 50 may be made of include a non-woven polypropylene, a polyethylene or other polymeric recyclable materials that are strong, flexible, water-resistant or waterproof and tear resistant. Flexible inventory bags or soft-sided containers 10 and 50 are similar in volume to a bin, but because it is flexible is capable of conforming to the inventory or merchandise being held in flexible inventory bags or soft-sided containers 10 and 50, which eliminates the “light load” problem discussed above. The flexibility of bags or soft-sided containers 10 and 50 and their ability to self-compress in a vehicle, such as a truck, trailer, van or other high volume transport vehicle makes them suitable for filling air gaps.

Besides the potential for more efficient truck and container utilization, in another embodiment, a stocker can wear or carry flexible inventory bag 10 or flexible inventory bag 50 and navigate through an aisle. For example and as illustrated in FIG. 1, flexible inventory bag 10 may include clips such as those shown for clipping to another element such as a strap or harness to make flexible inventory bag 10 wearable. Rather than having to move back and forth from the aisle to the cart filled with bins, the stocker can work more efficiently by focusing on stocking the merchandise from their wearable flexible inventory bag 10 to placement on the shelves or displays in an aisle.

In FIGS. 5-12, flexible inventory bag 50 includes a shoulder strap 52 having two opposing ends. The first end is attached proximate to an upper edge of the right side of bag 50 and the second end is attached proximate to an upper edge of the front side of bag 50. In particular, a cutout 54 in the front side of flexible inventory bag 50 is located substantially centrally and spaced apart from the upper edge of the front side of bag 50. The second end of shoulder strap 52 is located between cutout and the left side of bag 50.

To wear flexible inventory bag 50, a stocker orients the front side of bag 50 towards them, places shoulder strap 52 over their head and rests shoulder strap 52 on their right shoulder so that the upper edge of bag 50 is located at or near the stocker's bottom of their ribcage. Since shoulder strap 52 extends on only one side (the front side) of bag 50, the stocker has easy access to the contents inside bag 50 by pulling the back side of bag 50 away from the front side. In the alternative, flexible inventory bag 10 or flexible inventory bag 50 may be placed on a movable caddy for navigating through an aisle. For example, flexible inventory bag 10 or flexible inventory bag 50 are hung on the movable caddy and merchandise taken out of the bag to be stocked on the displays.

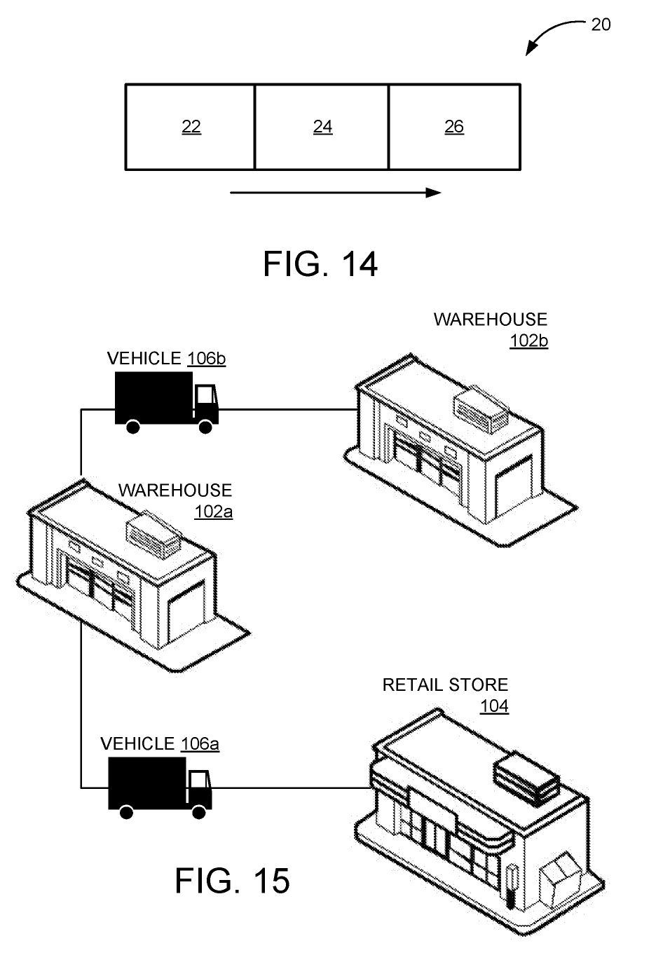

Still further, flexible inventory bags 10 and 50 may be color coded or graphically coded to help decrease search time in the aisle for item placement. For example FIG. 5 is a schematic top view of a gondola 20 that defines an aisle illustrated by the arrow and is split into three sections: a lead-in section 22, a middle section 24 and a lead out section 26. For example and as illustrated in FIG. 14, lead-in section 22 corresponds with a flexible inventory bag 10 or 50 that may be red, middle section 24 may correspond with a flexible inventory bag 10 or 50 that may be red and white striped and lead-out section 26 may correspond with a flexible inventory bag 10 or 50 that is white. For example, if a line of gondolas and therefore an aisle is 24 feet long and each section 22, 24 and 26 has a corresponding color coded or graphically coded section that is 8 feet long, then a stocker may need only to stand in one location and rotate between the gondolas that define the aisle instead of continually traversing 24 feet to place merchandise.

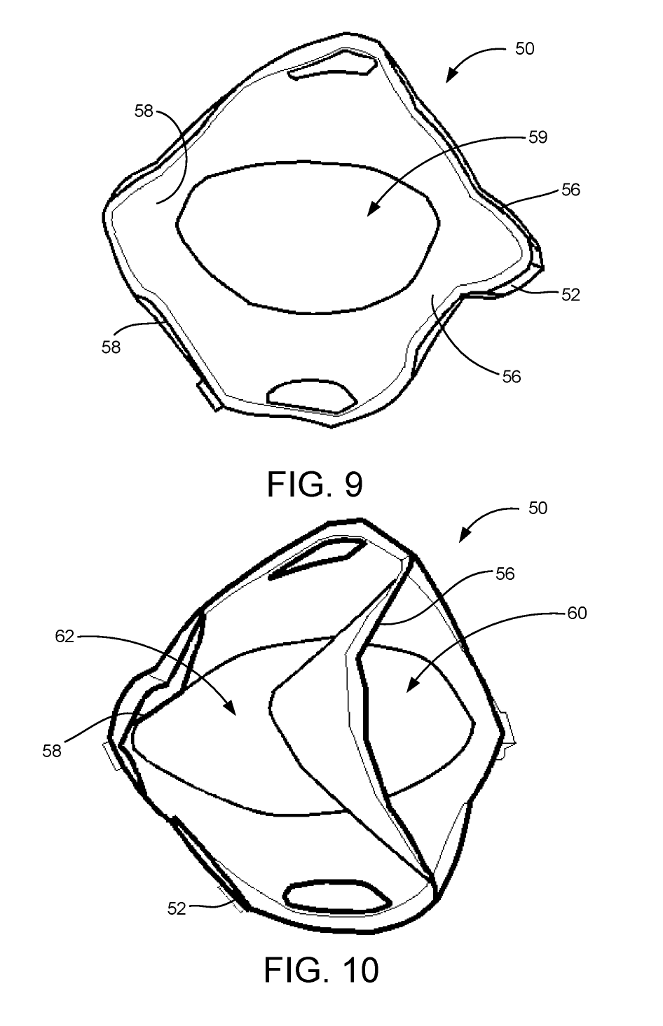

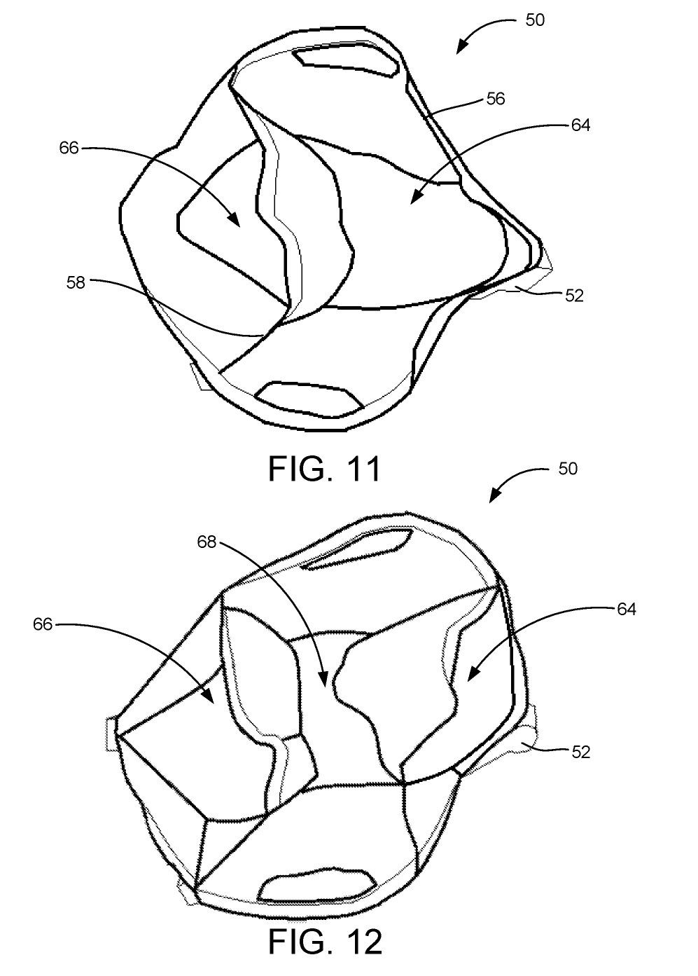

In addition, flexible inventory bag 10 may include dividers that form compartments 12 and 14 (FIG. 4) and flexible inventory bag 50 may include dividers 56 and 58 (FIG. 12) that form compartments. The compartments are for sorting items of merchandise from other items of merchandise. For flexible inventory bag 50, dividers 56 and 58 may be collapsed inside the interior of bag 50 so as to form one single large interior compartment 59 as illustrated in FIG. 9. In another embodiment and as illustrated in FIG. 10, divider 56 may be erected and divider 58 may be collapsed inside the interior of bag 50 so as to form two interior compartments 60 and 62. In this configuration, the right side compartment 60 has a smaller capacity than the left side compartment 62. In yet another embodiment and as illustrated in FIG. 11, divider 58 may be erected and divider 56 may be collapsed inside the interior of bag 50 so as to form two interior compartments 64 and 66. In this configuration, the left side compartment 66 is smaller than the right side compartment 64. In still another embodiment and as illustrated in FIG. 11, divider 56 may be erected and divider 58 may be erected so as to form three interior compartments 60, 66 and 68 inside the interior of bag 50.

All sorting of merchandise into flexible inventory bags 10 or 50 is performed prior to stocking. In the embodiment of using color or graphically coded bags and including pockets and dividers in the bags, the bags may increase the granularity of placement of merchandise for an aisle and increase the efficiency of stocking the gondolas that define an aisle. Bags 10 and 50 may also include an exterior clear pocket 15 (FIG. 1) and 70 (FIG. 5), respectfully. Clear pockets 15 and 70 may be filled with a label that identifies where the merchandise in the bag needs to go or be stocked and bags 10 and 50 may also indicate special circumstances like heavier weight or that there is fragile merchandise in the bag.

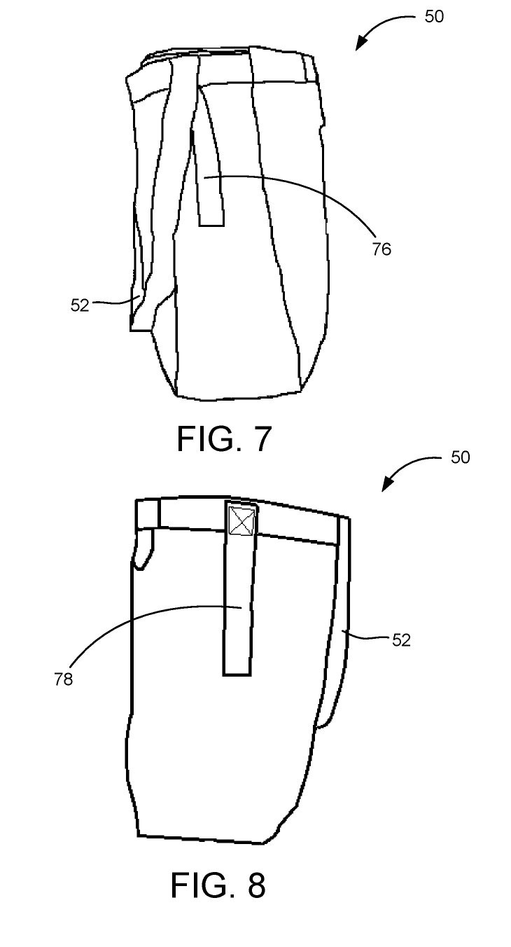

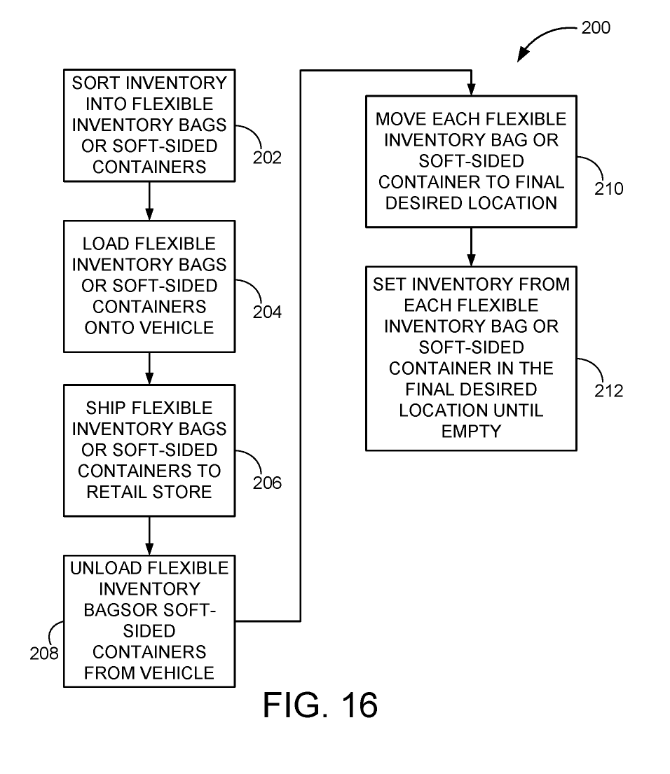

FIG. 15 illustrates a diagram 100 of supplying inventory, such as merchandise or non-merchandise, from, for example, a warehouse 102a to a retail store 104 or from a warehouse to another warehouse 102b or other building, such as a distribution center, in a retail chain. FIG. 7 illustrates a flow diagram 200 of a method of supplying inventory according to an embodiment. At warehouse 102a, requests for inventory, whether merchandise or non-merchandise, are received for those items that are low in supply or needed at a retail store 104 or are needed at another building 102b. At block 202 of FIG. 16, the inventory requested is sorted into flexible inventory bags or soft-sided containers, such as bags 10 or 50. In one embodiment, when requested inventory is for retail store 104, inventory may be sorted into flexible inventory bags or soft-sided containers based on a final desired location that the inventory is to be placed, for example the inventory is merchandise and the merchandise is sorted into a flexible inventory bag for a final desired aisle or portion of an aisle in that retail store. When requested inventory is for another type of building, such as building or warehouse 102b, or for movement of inventory from one location in the building or warehouse to another location in the same building or warehouse, inventory may be sorted into flexible inventory bags based on other sorting principles. As illustrated in block 204 and after inventory is sorted, the flexible inventory bags or soft-sided containers are loaded onto vehicle 106a or 106b, such as a truck or other type of transport vehicle, for transport to retail store 104 or warehouse 102b.

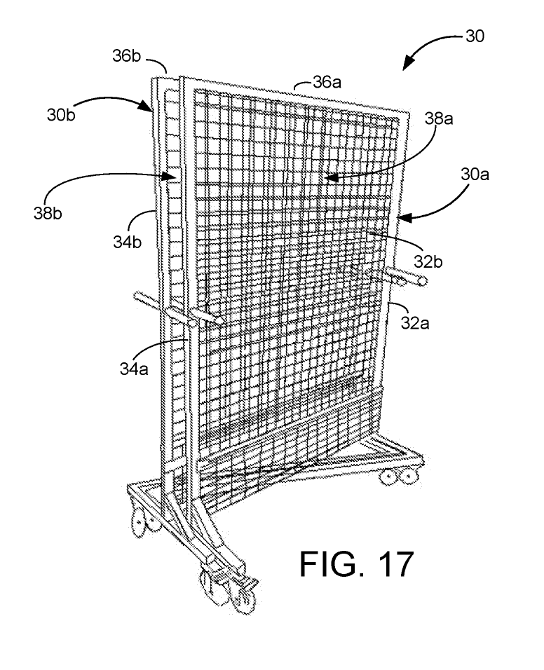

Under one embodiment, the flexible inventory bags may be first loaded onto a cart and then the cart, with the flexible inventory bags attached, are loaded onto vehicle 106a or 106b. FIG. 17 illustrates one embodiment of an exemplary cart 30. It should be realized, however, that any type of cart design should be considered for supporting and holding bags.

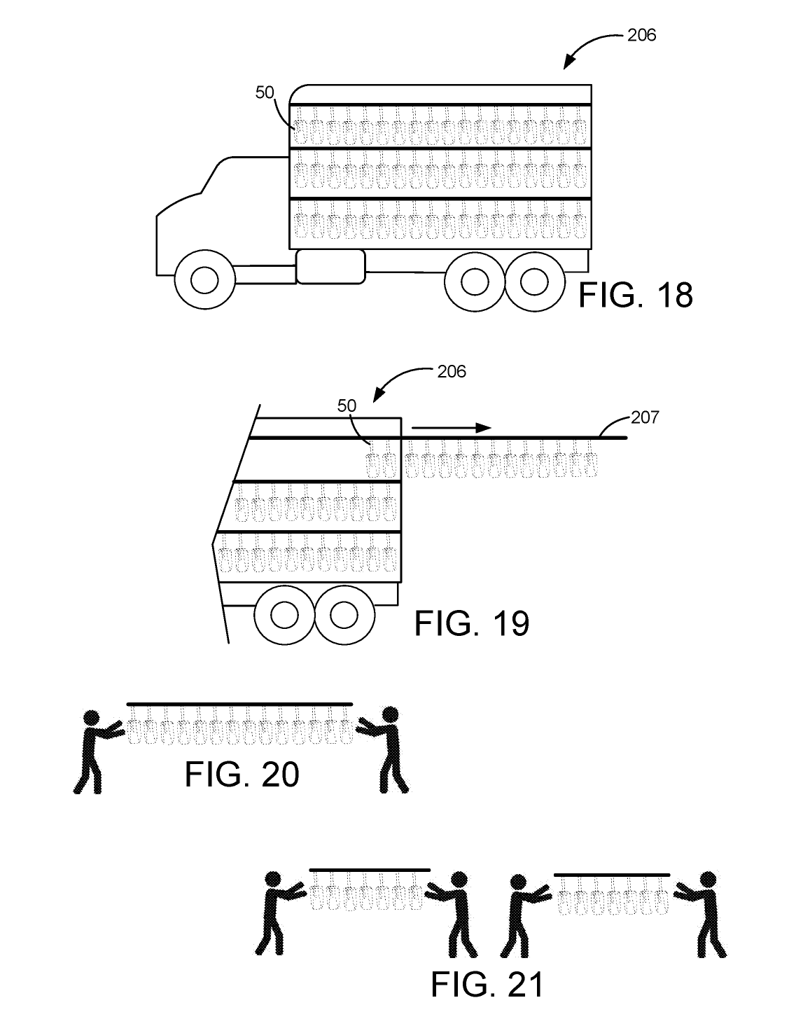

In addition, other types of racks can be used for holding flexible inventory bags 10 in a vehicle including railing systems installed in trucks and trailers. FIG. 18 illustrates a schematic diagram of one embodiment of a railing system within a trailer of a truck 206 that holds flexible inventory bags 50 for transport. With a railing system, better truck utilization may be obtained because railings are placed as high as the ceiling of a truck or trailer and as low as just off of the floor of the truck or trailer. FIG. 19 illustrates a schematic diagram of the unloading of flexible inventory bags 50 from the railing system in the trailer of truck 206. In this embodiment, a fixture 207 is used to unload bags 50 from truck 206. Fixture 207 is shown as a basic rail or rails that mate with a rail or rails in the trailer of truck 206. In this way, bags 50 may be slid off the rail or rails of the railing system in the trailer of truck 206 right onto fixture 207. In one embodiment, fixture 207 is movable so that it may be transported into the retail store into the back room or directly onto the store floor.

FIG. 20 illustrates fixture 207 away from truck 206 in either a location in the backroom or on the store floor. In this embodiment, fixture 207 may be worked on from both ends by team members in the store. FIG. 21 illustrates another configuration of fixture 207, where at the destination fixture 207 is split into fixtures halves 207a and 207b. In the embodiment illustrated in FIG. 21, fixture 207 split into fixture halves 207a and 207b may be worked from both ends of each half to allow four team members. In yet another embodiment, the rail fixture that mates with rails in the trailer of the truck may extend all the way to the destination, for example, transported on rails of the ceiling in the retail store.

In another embodiment, soft-sided containers, such as flexible inventory bags 50, may be placed in shipping vessels that can be loaded into vehicle 106a or 106b and stacked one on top of each other.

With reference back to FIG. 17, two of the same exemplary carts 30a and 30b are nested together. Carts 30a and 30b are racks that include z-shaped bases each with four wheels attached to each z-shaped base. The z-shaped base provides durability, large weight capacity and ease of nesting for purposes of storing. Each cart 30a and 30b also includes a pair of uprights 32a and 32b and 34a and 34b with an upper cross bar 36a and 36b connecting the tops of each upright. Spanning the distance between the uprights and extending from the upper cross bar to the z-shaped base is a grid 38a and 38b. Grid 38a and 38b provides an area for the flexible inventory bags to be hung on hooks or otherwise mounted to grids 38a and 38b. Grids 38a and 38b allow the flexible inventory bags to be placed anywhere along the width and height and on both sides of cart 30a and 30b.

For flexible inventory bag 50, cutout 54 located on the front side (see FIG. 5) corresponds with a cutout 55 located on the back side (see FIG. 6). Not only can a user insert their hand through both cutout 54 and cutout 55 to carry bag 50 to a location to set inventory, but cutout 54 and cutout 55 can be used to hang bag 50 from a hook on a cart, such as either cart 30a or 30b. In particular, cutouts 54 and 55 receive a hook. Added strength is given to bag 50 by adding a first section of webbing 72 to the area between cutout 54 on first side of bag 50 and an upper edge of bag 50 and by adding a second section of webbing 74 to the area between cutout 54 on the second side of bag 50 and an upper edge of bag 50. To hang up bag 50, a user can insert a right hand through a right sided handle 76 that is located on the right side of bag 50 and insert a left hand through a left sided handle 78 that is located on the left side of bag 50. See FIG. 6 where right sided handle 76 is shown in phantom as being pulled away from the right side of bag 50 and where left sided handle 78 is shown in phantom as being pulled away from the left side of bag 50. Handles 76 and 78 are also shown in the right and left side views of FIGS. 7 and 8 where handles 76 and 78 are in a relaxed configuration.

With reference back to blocks 204 and 206 of FIG. 16 and under one embodiment, the flexible inventory bags are loaded onto a vehicle, such as vehicles 106a and 106b, using carts, such as rolling carts 30a and 30b. By using the flexible inventory bags mounted to carts 30a and 30b, space in the vehicle is optimized because of the flexible nature of the bags. The flexible inventory bags and their supporting carts 30a and 30b are transported or shipped to a building whether it be a retail store or a warehouse.

At retail store 104 or building 102b and as illustrated in block 208, the flexible inventory bags or soft-side containers are unloaded from vehicle 106a or 106b. In the case where flexible inventory bags are mounted to carts 30a and 30b, the carts 30a and 30b are wheeled off the vehicle and into retail store 104 or building 102b. In the instance where vehicle 106a ships flexible retail bags or soft-side containers to retail store 104, the flexible inventory bags or soft-sided containers are unloaded from vehicle 106a into, for example, a backroom.

At block 210, each flexible inventory bag is moved to a final desired location in retail store 104 or warehouse or other building type 102b. In one embodiment and in the case where the inventory is for order fulfillment, the flexible inventory bags are moved to a final desired location within the backroom of retail store 104. In some cases, a portion of a backroom may be used to fulfill orders, such as on-line orders, and includes inventory that may or may not be inventory the retail store stocks on the store floor. In another embodiment, the flexible inventory bags or soft-sided containers are moved to a final desired location on the store floor of the retail store for restocking shelves and displays 104 with merchandise or in the alternative altering or changing display fixtures. In one example, carts 30 used in transporting the flexible inventory bags from warehouse 102a to warehouse 102b or retail store 104 are also used to move the flexible inventory bags to their final desired locations. In another example, a special type of caddy or other type of movable or wheeled device may be used to transport the bags or soft-sided containers from the backroom out onto to the store floor. This special caddy or other type of movable device may or may not also be used in the shipping of the flexible inventory bags from warehouse 102a to warehouse 102b or to retail store 104 and may or may not be specially constructed to receive flexible bags off of a vehicle that has shipped or transported flexible inventory bags from warehouse 102a.

After moving the flexible inventory bags to the final desired location, at block 212 a team member sets inventory from each flexible inventory bag or soft-sided container until the bag is empty. In one example, a team member moves the flexible inventory bag or soft-sided container to the final desired location. The team member empties the contents of the bag or container onto shelves or other display fixtures in, for example, the aisle.

In one example, a team member may wear a harness that a flexible inventory bag can be attached to while placing merchandise from the bag onto shelves. The harness may be a body torso strap and the like. In another example, the team member may have their own personal caddy, much like a wheeled pole with hooks, which supports the flexible inventory bags while items from the bags are placed on the shelves. In still another example, the flexible inventory bags may have their own integral strap system so that the team member may wear the bag without any further devices while placing merchandise from the bags on the shelves.

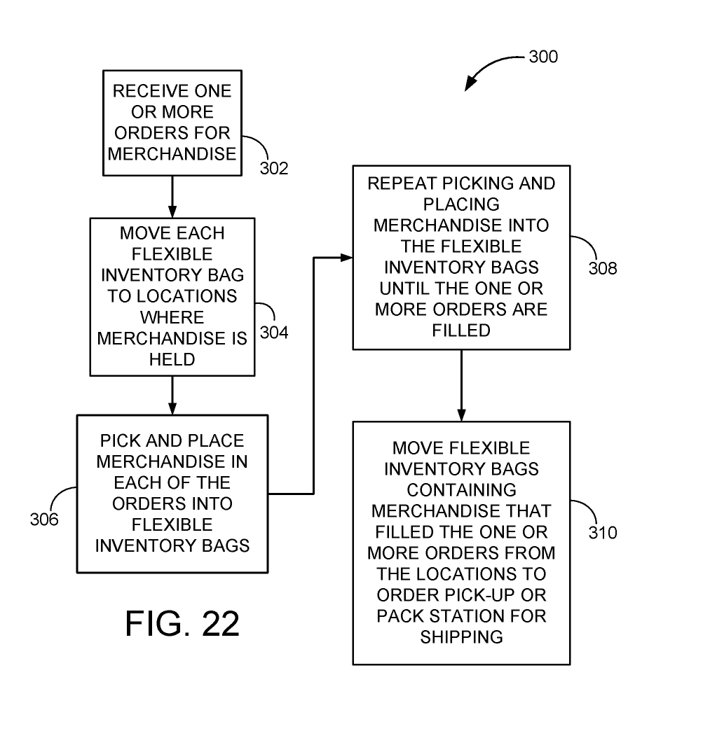

FIG. 22 illustrates a flow diagram 300 of a method of supplying inventory according to another embodiment. As previously discussed in order fulfillment, customers order merchandise on-line or by other means, such as by an app or by telephone orders. At block 302, one or more of those orders are received by the retailer. After receipt of the order, the retailer proceeds to fulfill the order. Example fulfillment includes gathering in-store merchandise for the order for pick-up, gathering in-store merchandise for the order and shipping the merchandise from the store to the customer or a warehouse or gathering merchandise for the order from inventory held in a warehouse and shipping the merchandise to the customer. In any of these scenarios, orders are picked by team members.

At block 304, the flexible inventory bags or soft-side containers are moved by team members to locations in a building where merchandise is being held, such a location on the store floor of a retail store, a location in the backroom of the retail store or a location in a warehouse. As discussed in regards to the embodiments described with FIG. 16, a team member may wear a harness so as to attach one of the flexible inventory bags to the harness for moving the bag to the location. The harness may be a body torso strap and the like. In another example, the team member may have their own personal caddy, much like a wheeled pole with hooks, which supports the flexible inventory bags. In still another example, the flexible inventory bags may have their own integral strap system so that the team member may wear the bag without any further devices so as to move the bag to the desired location.

At block 306, the team member picks and places merchandise in each of the orders into the flexible inventory bags. At block 308, the team member repeats picking and placing merchandise into the flexible inventory bags until one or more orders are filled or another bag is needed. At block 310, the team member moves the flexible inventory bags from the desired location to order pick-up or a pack station for shipping to a customer. In one embodiment, the team member is still wearing or using an individual caddy to move the flexible inventory bag. However, the movement described in block 310 may also be accomplished by carts 30 or the like that are also used in transporting, by vehicle, inventory from a warehouse to another warehouse or to the retail store.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of supplying inventory comprising:
sorting inventory into flexible inventory bags, each flexible inventory bag that receives the inventory corresponds with a final desired location in a building of a retailer;
loading the flexible inventory bags onto a vehicle;
shipping the flexible inventory bags from a warehouse to the building on the vehicle;
unloading the flexible inventory bags from the vehicle into the building;
moving each flexible inventory bag to the final desired location in the building; and
setting inventory from each flexible inventory bag in the final desired location.

2. The method of claim 1, wherein the final desired location is an aisle in the building.

3. The method of claim 2, wherein the final desired location is a section of the aisle in the building.

4. The method of claim 1, wherein loading the flexible inventory bags onto a vehicle comprises hanging the flexible inventory bags on movable carts and loading the movable carts onto the vehicle for shipping.

5. The method of claim 4, wherein unloading the flexible inventory bags from the vehicle comprises unloading the movable carts from the vehicle.

6. The method of claim 5, wherein moving each flexible inventory bag to the final desired location comprises transporting the movable carts to the final desired location.

7. The method of claim 1, wherein setting inventory from each flexible inventory bag in the final desired location comprises carrying the flexible inventory bag to set inventory from the flexible inventory bag.

8. The method of claim 1, wherein setting inventory from each flexible inventory bag into the final desired location comprises wearing the flexible inventory bag to set inventory from the bag.

9. The method of claim 1, wherein setting inventory from each flexible inventory bag in the final desired location comprises using a movable device to support the flexible inventory bag and moving the movable device to the final desired location to set inventory from the bag.

10. A method of supplying inventory comprising:
receiving one or more orders for merchandise;
moving a flexible inventory bag to locations where the merchandise is being held;
picking and placing the merchandise listed in each of the orders into at least one flexible inventory bag;
repeating the picking and placing of merchandise into the flexible inventory bags until the one or more orders are filled; and
moving the flexible inventory bags that contain the merchandise that filled the one or more orders from the locations where merchandise is being held to an order pick-up location or a pack station for shipping.

11. The method of claim 10, wherein the locations where merchandise is being held comprise display fixtures on a store floor.

12. The method of claim 10, wherein the locations where merchandise is being held comprise locations in a warehouse.

13. The method of claim 10, wherein the locations where merchandise is being held comprise locations in a backroom of a retail store.

14. The method of claim 10, wherein the one or more orders comprise one or more on-line orders.

15. The method of claim 10, wherein moving a flexible inventory bag to locations where the merchandise in each of the orders is being held comprises:
removing one of the flexible inventory bags on a movable cart; and
carrying the removed flexible inventory bag to pick and place inventory into the flexible inventory bag.

16. The method of claim 10, wherein moving a flexible inventory bag to locations where the merchandise in each of the orders is being held comprises:
removing one the flexible inventory bags from a movable cart; and
wearing the removed flexible inventory bag to pick and place inventory into the flexible inventory bag.

17. The method of claim 10, wherein moving a flexible inventory bag to locations where the merchandise in each of the orders is being held comprises:
removing one of the flexible inventory bags from a movable cart;
supporting the removed flexible inventory bag on a movable device; and
using the movable device to pick and place inventory into the flexible inventory bag.

18. A method of supplying inventory comprising:
sorting inventory into soft-sided containers, each soft-sided container that receives the inventory corresponds with a final desired location in a building of a retailer;
transporting each soft-sided container to the final desired location; and
setting inventory from the soft-sided container into the final desired location.

19. The method of claim 18, wherein transporting each soft-sided container to the final desired location comprises:
transporting each soft-sided container filled with inventory from a first building to a second building on a vehicle, wherein each soft-sided container self-compresses on the vehicle to fill air gaps; and
transporting each soft-sided container filled with inventory from the vehicle to the final desired location, wherein the final desire location is in the second building.

20. The method of claim 18, wherein transporting each soft sided container to the final desire location comprises supporting each soft-sided container filled with inventory on a movable device that is movable from a first area in a building to the final desired location in the same building.
